(19) United States
(12) Patent Application Publication
(10) Pub. No.: US 2014/0021815 A1
(43) Pub. Date: Jan. 23, 2014

(54) ELECTRICITY COLLECTION AND DISTRIBUTION RING AND ELECTRIC MOTOR

(71) Applicant: Hitachi Metals, Ltd., Tokyo (JP)

(72) Inventors: Kazuhiko TOMITA, Mito (JP); Kenichi EGAMI, Kitaibaraki (JP)

(73) Assignee: Hitachi Metals, Ltd., Tokyo (JP)

(21) Appl. No.: 13/947,784

(22) Filed: Jul. 22, 2013

(30) Foreign Application Priority Data
Jul. 23, 2012 (JP) 2012-163034

(51) Int. Cl. H02K 3/50

(52) U.S. Cl. CPC H02K 3/50
USPC 310/71

(57) ABSTRACT

An electricity collection and distribution ring includes a plurality of bus rings for collecting and distributing respective phase currents to multiple-phase windings wound around a plurality of circularly-arranged teeth. The plural bus rings each include a plurality of terminal parts and a main body part electrically conducted to the plural terminal parts. One bus ring having the largest number of terminal parts among the plural bus rings includes the main body part and the terminal parts that are integrally formed with a plate-shaped metal member being bent. Other bus rings of the plural bus rings excluding the one bus ring are configured such that the main body part includes an annular insulated wire including a conductor and an insulation covering the conductor, and the terminal parts are connected to the main body part at a plurality of positions where the conductor is exposed with the insulation removed.

The present application is based on Japanese Patent Application No. 2012-163034 filed on Jul. 23, 2012, the entire contents of which are incorporated herein by reference.

### BACKGROUND OF THE INVENTION

1. Field of the Invention

The invention relates to an electricity collection and distribution ring and an electric motor using the electricity collection and distribution ring.

2. Description of the Related Art

An electricity collection and distribution ring is known that collects and distributes motor current from and to windings of a stator in, e.g., a three-phase AC motor (see, e.g., JP-A-2010-63273).

The stator disclosed in JP-A-2010-63273 has an annularly-formed insulating holder having electrical insulation properties, plural bus bars (four phases: U-, V-, W- and neutral phases) held by the insulating holder, and plural coils wound around plural bobbins. On the insulating holder, three annular projections are formed so as to be interposed between the radially adjacent bus bars. The projections may increase a creepage distance between the bus bars and improve insulation reliability.

### SUMMARY OF THE INVENTION

In order to enhance the insulation reliability, it is necessary to ensure not only a creepage distance between the bus bars but also a spatial distance therebetween. For the stator disclosed in JP-A-2010-63273, it is desirable that a top portion of the projection protrude beyond a widthwise edge of the bus bar in order to ensure the spatial distance between the bus bars. However, forming the projection as such causes a problem that an axial dimension of the insulating holder increases, which increases the size of the stator.

Instead of using the plural bus bars, plural insulated wires each formed by covering a conductor with an insulation layer could be used to ensure insulation reliability such that end portions of coil windings and the conductors of the insulated wires are connected by plural terminals. However, man-hours for partially removing the insulation layers and for connecting the terminals increase in this case.

It is an object of the invention to provide an electricity collection and distribution ring that can ensure the insulation reliability while suppressing an increase in manufacturing man-hours and in size, as well as to provide an electric motor.
(1) According to one embodiment of the invention, an electricity collection and distribution ring comprises:

a plurality of bus rings for collecting and distributing respective phase currents to multiple-phase windings wound around a plurality of circularly-arranged teeth,

wherein the plurality of bus rings each comprise a plurality of terminal parts and a main body part electrically conducted to the plurality of terminal parts,

wherein one bus ring having the largest number of terminal parts among the plurality of bus rings comprises the main body part and the terminal parts that are integrally formed with a plate-shaped metal member being bent, and

wherein other bus rings of the plurality of bus rings excluding the one bus ring are configured such that the main body part comprises an annular insulated wire comprising a conductor and an insulation covering the conductor, and the terminal parts are connected to the main body part at a plurality of positions where the conductor is exposed with the insulation removed.

In the above embodiment (1) of the invention, the following modifications and changes can be made.

(i) The plurality of bus rings are concentrically arranged about an axis of the plurality of circularly-arranged teeth.

(ii) The one bus ring is arranged on the innermost or outermost side of the plurality of bus rings.

(iii) The terminal parts of the one bus ring protrude radially outward and the terminal parts of the other bus rings protrude radially inward, and

wherein one-side end portions and other-side end portions of the multiple-phase windings are connected to the terminal parts at positions between the other bus rings and the one bus ring.

(iv) The terminal part of the one bus ring is arranged between the terminal parts of the other bus rings.

(v) The terminal parts of the other bus rings each comprises a first coupling portion extending along the main body part and a second coupling portion extending parallel to an axial direction from an end portion of the first coupling portion.

(vi) The plurality of teeth and the multiple-phase windings compose a stator of a three-phase AC motor to which U-, V- and W-phase currents are supplied, wherein the other bus rings comprise a first bus ring having the plurality of terminal parts connected to one-side end portions of a plurality of U-phase windings, a second bus ring having the plurality of terminal parts connected to one-side end portions of a plurality of V-phase windings and a third bus ring having the plurality of terminal parts connected to one-side end portions of a plurality of W-phase windings, and

wherein the one bus ring comprises a neutral-phase bus ring connected to respective other-side end portions of the plurality of U-, V- and W-phase windings.

(vii) The one-side end portions and the other-side end portions of the plurality of U-, V- and W-phase windings are connected to the terminal parts at positions between the first to third bus rings and the neutral-phase bus ring.

(viii) The electricity collection and distribution ring further comprises an annular holding member for holding the first to third bus rings and the neutral-phase bus ring, wherein the holding member comprises guide portions for guiding the one-side end portions and the other-side end portions of the plurality of U-, V- and W-phase windings to between the first to third bus rings and the neutral-phase bus ring.
(2) According to another embodiment of the invention, an electric motor comprises:

the electricity collection and distribution ring according to the above embodiment (1);

a stator comprising the plurality of teeth and the multiple-phase windings; and

a rotor that is rotated with respect to the stator by a magnetic field of the multiple-phase winding.

### Points of the Invention

According to one embodiment of the invention, an electricity collection and distribution ring is constructed such that the terminal parts of a fourth bus ring (=one bus ring for the neutral phase) are integrally formed with a plate-shaped metal member being bent. Thereby, the work of connecting the main body part to the terminal parts is eliminated. This allows man-hours for manufacturing the electricity collection and distribution ring to be reduced as compared to the case that the fourth bus ring is composed of, e.g., an annular wire and plural terminal parts connected thereto by clamping.

### BRIEF DESCRIPTION OF THE DRAWINGS

Next, the present invention will be explained in more detail in conjunction with appended drawings, wherein:

FIG. 1 is an explanatory diagram illustrating a structural example of an electricity collection and distribution ring in an embodiment of the present invention and an electric motor provided therewith;

FIGS. 2A to 2C show a holding member, wherein FIG. 2A is a plan view, FIG. 2B is a partial enlarged view of FIG. 2A and FIG. 2C is a cross sectional perspective view taken on line A-A of FIG. 2A;

FIGS. 3A and 3B show first to fourth bus rings, wherein FIG. 3A is a plan view and FIG. 3B is a cross sectional view showing the first to fourth bus rings which are housed in the holding member;

FIG. 4 is a perspective view showing a terminal and the periphery thereof;

FIGS. 5A and 5B show an arcuate conductor, wherein FIG. 5A is a perspective view and FIG. 5B is a plan view as viewed from an axial direction of the fourth bus ring; and

FIGS. 6A to 6D show a holding member and first to fourth bus rings in Comparative Example, wherein FIG. 6A is a cross sectional view showing the holding member and the first to fourth bus rings, FIG. 6B is a cross sectional view showing the first to fourth bus rings, FIG. 6C is a cross sectional view showing the holding member and FIG. 6D is a perspective view showing a terminal part of the second bus ring and the periphery thereof.

### DETAILED DESCRIPTION OF THE PREFERRED EMBODIMENTS

### Embodiment

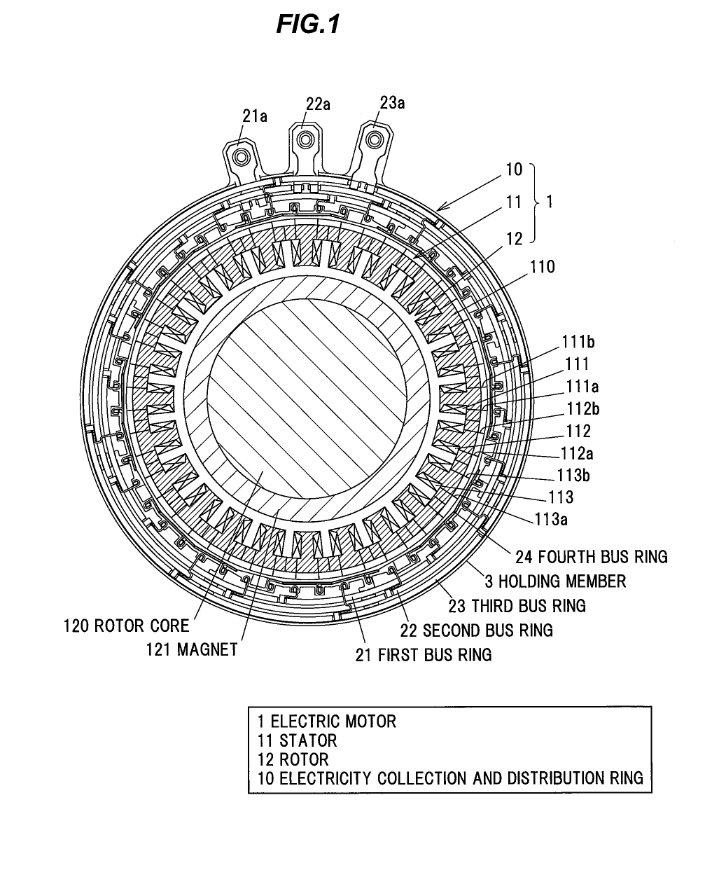

The embodiment of the invention will be described in reference to FIGS. 1 to 5B.

FIG. 1 is an explanatory diagram illustrating a structural example of an electricity collection and distribution ring in the embodiment of the invention and an electric motor provided therewith.

An electric motor 1 is a three-phase AC motor provided with a stator 11, a rotor 12 and an electricity collection and distribution ring 10 for collecting and distributing motor current to the stator 11. Note that, although the electricity collection and distribution ring 10 and the stator 11 in the electric motor 1 are aligned along a rotational axis of the rotor 12, the stator 11 in FIG. 1 is shown inside the electricity collection and distribution ring 10 as a matter of convenience.

Multiple phase windings 111, 112 and 113 each covered with an insulation of e.g., enamel are wound around plural teeth 110 formed of a magnetic material and circularly arranged about an axis 0, thereby forming the stator 11. The U-phase winding 111, the V-phase winding 112 or the W-phase winding 113 is wound around each tooth 110. U-phase, V-phase and W-phase currents are respectively supplied to the multiple phase windings 111, 112 and 113. Here, the axis O is the center of the circularly-arranged plural teeth 110 and substantially coincides with the rotational axis of the rotor 12.

The electricity collection and distribution ring 10 is provided with first to fourth bus rings 21 to 24 for collecting and distributing power to the windings 111, 112 and 113, and an annular holding member 3 for holding the first to fourth bus rings 21 to 24. Power supply terminals 21a, 22a and 23a are respectively provided on the first to third bus rings 21 to 23 at a position in a circumferential direction thereof. The power supply terminals 21a, 22a and 23a protrude radially outward of the first to third bus rings 21 to 23 and are connected to a non-illustrated inverter.

The first to third bus rings 21 to 23 distribute motor current output from the inverter to the U-, V- and W-phase windings 111, 112 and 113 of the electric motor 1. The fourth bus ring 24 is a neutral-phase bus ring of the stator 11 and is connected to respective end portions of the windings 111, 112 and 113.

A one-side end portion 111a of the U-phase winding 111 is electrically connected to the first bus ring 21. Another-side end portion 111b of the U-phase winding 111 is electrically connected to the fourth bus ring 24. Likewise, one-side end portions 112a and 113a of the V- and W-phase windings 112 and 113 are electrically connected to the second and third bus rings 22 and 23 and other-side end portions 112b and 113b of the windings 112 and 113 are electrically connected to the fourth bus ring 24.

The rotor 12 has a rotor core 120 rotatably supported by a non-illustrated shaft bearing so as to be coaxial with the stator 11 and a magnet 121 having plural magnetic poles and fixed to an outer peripheral surface of the rotor core 120.

Motor currents having sine waveforms 120 degrees out of phase with each other are supplied to the U-, V- and W-phase windings 111, 112 and 113 from the non-illustrated inverter and this creates a rotating magnetic field in the stator 11. The magnet 121 receives a torque generated by an attractive force and a repulsive force caused by the rotating magnetic field and the rotor core 120 is rotated with respect to the stator 11 by the torque.

Structure of Holding Member

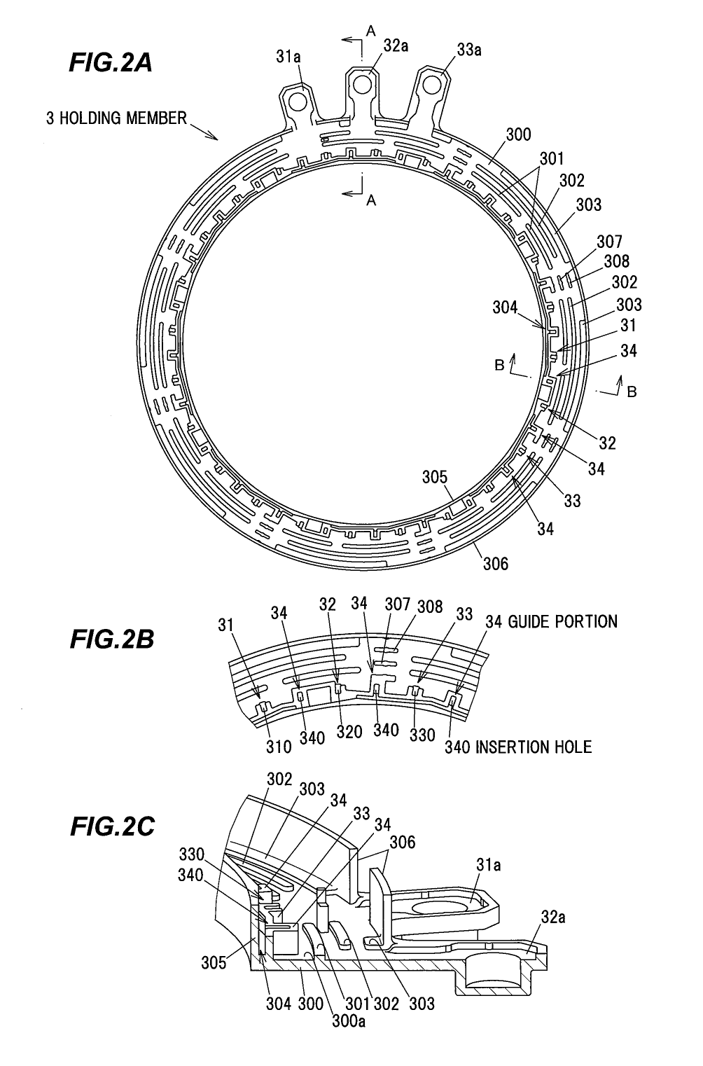

FIGS. 2A to 2C show the holding member 3, wherein FIG. 2A is a plan view, FIG. 2B is a partial enlarged view of FIG. 2A and FIG. 2C is a cross sectional perspective view taken on line A-A of FIG. 2A.

The holding member 3 is made of, e.g., an injection-molded resin and is formed in a squared-C shape in cross section so as to have a housing space for housing the first to fourth bus rings 21 to 24. The holding member 3 has plural first protrusions 301 which are formed on a bottom wall 300 so as to correspond to the first bus ring 21. The plural first protrusions 301 each have an arc shape and are formed along the first bus ring 21. In addition, the holding member 3 has plural second and third arc-shaped protrusions 302 and 303 which are formed on the bottom wall 300 so as to correspond to the second and third bus rings 22 and 23.

The plural first to third protrusions 301 to 303 are concentrically formed such that the plural second protrusions 302 are located on the outer side of the plural first protrusions 301 and the plural third protrusions 303 are located on the outer side of the plural second protrusions 302. In addition, the plural first to third protrusions 301 to 303 protrude from a bottom surface 300a of the holding member 3 on the bottom wall 300 to increase a creepage distance between the bottom surface 300a and the first to third bus rings 21 to 23.

In addition, plural holding grooves 304 which partially house the fourth bus ring 24 are formed on the holding member 3 to hold the fourth bus ring 24. Each of the plural holding grooves 304 has an arc shape and is formed so as to be recessed in an axial direction of the holding member 3 toward the bottom surface 300a. In the present embodiment, the plural holding grooves 304 are formed on the inner side of the plural first to third protrusions 301 to 303.

The holding member 3 also has an inner wall 305 and an outer wall 306 which protrude in a direction orthogonal to the bottom surface 300a (i.e., in the axial direction of the holding member 3) respectively from inner and outer edges of the bottom wall 300. The inner wall 305 serves as an inner peripheral surface of the holding grooves 304. The outer wall 306 is formed continuously with the third protrusions 303.

In addition, the holding member 3 has guide portions 31, 32, 33 and 34. The guide portions 31, 32 and 33 guide the one-side end portions 111a, 112a and 113a of the windings 111, 112 and 113 to connecting portions of terminals 211, 221 and 231 of the below-described first to third bus rings 21 to 23 and the guide portions 34 guide the other-side end portions 111b, 112b and 113b of the windings 111, 112 and 113 to connecting portions of terminal parts 241, 242 and 243 of the below-described fourth bus ring 24. In the present embodiment, the holding member 3 has guide portions 31, 32 and 33 of eight each and twenty-four guide portions 34.

An insertion hole 310 for inserting the one-side end portion 111a of the winding 111 is formed on the guide portion 31. Likewise, insertion holes 320 and 330 for inserting the one-side end portions 112a and 113a of the windings 112 and 113 are respectively formed on the guide portions 32 and 33. And likewise, an insertion hole 340 for inserting the other-side end portion 111b, 112b or 113b of the winding 111, 112 or 113 is formed on the guide portion 34. The detailed structure of the guide portions 31 to 34 will be described later.

The holding member 3 also has power supply terminal housing portions 31a, 32a and 33a for housing the power supply terminals 21a, 22a and 23a, plural partition walls 307 for separating the housing space of the first bus ring 21 from that of the second bus ring 22 and plural partition wall 308 for separating the housing space of the second bus ring 22 from that of the third bus ring 23.

Structure of First to Fourth Bus Rings

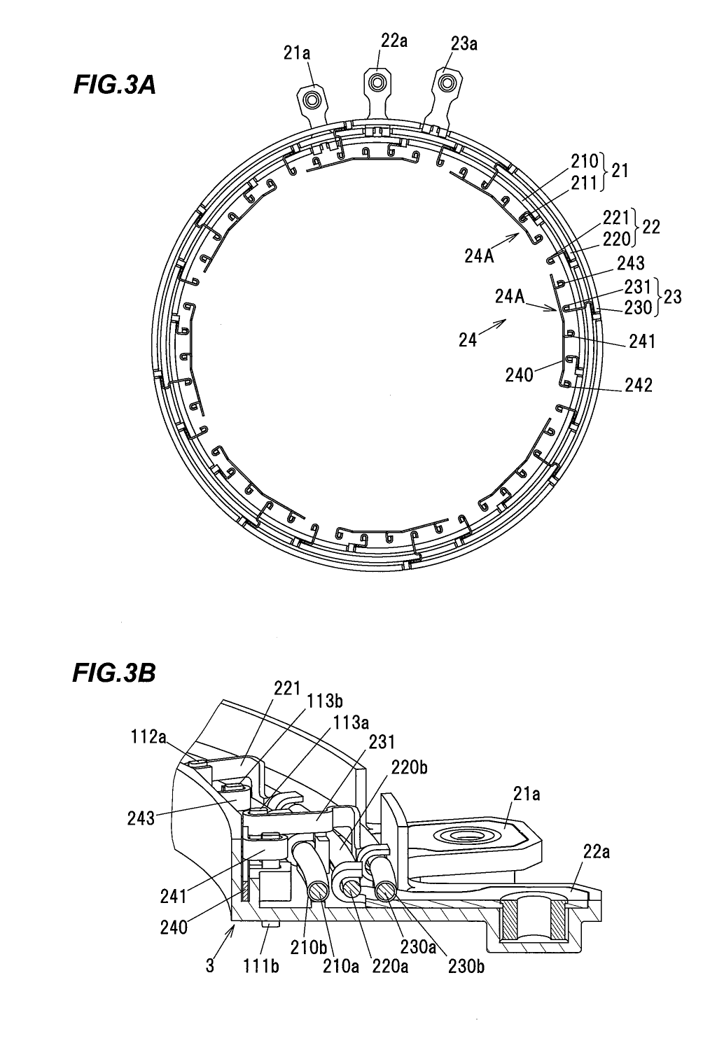

FIGS. 3A and 3B show the first to fourth bus rings 21 to 24, wherein FIG. 3A is a plan view and FIG. 3B is a cross sectional view showing the first to fourth bus rings 21 to 24 housed in the holding member 3 which is also shown.

The first bus ring 21 has an annular electric wire 210 as a main body part, the terminals 211 as terminal parts connected to the electric wire 210 at plural circumferential positions and the power supply terminal 21a. In the present embodiment, the first bus ring 21 has eight terminals 211 which are arranged at regular intervals. The one-side end portions 111a of the windings 111 inserted through the insertion holes 310 of the guide portions 31 of the holding member 3 are respectively connected to the plural terminals 211.

Both ends of the electric wire 210 are clamped and fixed to the power supply terminal 21a. The electric wire 210, which is a round wire having a circular cross section, is an annular insulated wire having a conductor 210a formed of a metal having good conductivity such as copper and an insulation 210b formed of an insulating resin covering the conductor 210a. At the connecting portion between the terminal 211 and the electric wire 210, one end of the terminal 211 is fixed by clamping to the conductor 210a which is exposed by removing the insulation 210b. Accordingly, the plural terminals 211 are electrically connected to the conductor 210a of the electric wire 210.

Likewise, the second bus ring 22 has an annular electric wire 220, the terminals 221 arranged at plural circumferential positions on the electric wire 220 and the power supply terminal 22a to which both ends of the electric wire 220 are clamped and fixed. In addition, the third bus ring 23 has an annular electric wire 230, the terminals 231 arranged at plural circumferential positions on the electric wire 230 and the power supply terminal 23a to which both ends of the electric wire 230 are clamped and fixed.

The electric wires 220 and 230 as main bodies are annular insulated wires respectively having conductors 220a and 230a and insulations 220b and 230b formed of an insulating resin covering the conductors 220a and 230b, and the terminals 221 and 231 as terminal parts are fixed by clamping to the conductors 220a and 230a which are exposed by removing the insulations 220b and 230b.

The one-side end portions 112a of the windings 112 inserted through the insertion holes 320 of the guide portions 32 of the holding member 3 are respectively connected to the plural terminals 221 of the second bus ring 22. In addition, the one-side end portions 113a of the windings 113 inserted through the insertion holes 330 of the guide portions 33 of the holding member 3 are respectively connected to the plural terminals 231 of the third bus ring 23.

The one-side end portions 111a, 112a and 113a of the windings 111, 112 and 113 inserted through the insertion holes 310, 320 and 330 of the guide portions 31, 32 and 33 of the holding member 3 are respectively connected to the plural terminals 211, 221 and 231.

The fourth bus ring 24 is composed of plural arcuate conductors 24A each having an arc shape and is formed in an annular shape as a whole by sequentially arranging the arcuate conductors 24A at predetermined intervals along a circumferential direction of the holding member 3.

The arcuate conductor 24A has a main body part 240 bent into an arc shape and plural (three) terminal parts 241, 242 and 243 provided on the main body part 240 at plural (three) circumferential positions so as to protrude in a radial direction of the fourth bus ring 24. In the present embodiment, the fourth bus ring 24 is composed of eight arcuate conductors 24A and has twenty-four (3×8) terminal parts (terminal parts 241, 242 and 243) in total at equal intervals. The main body part 240 and the terminal parts 241, 242 and 243 are integrally formed by bending a plate-shaped metal member and are electrically conducted to each other. The detailed structure of the arcuate conductor 24A will be described later.

The first to fourth bus rings 21 to 24 are concentrically arranged about the axis 0 of the circularly-arranged plural teeth 110. In other words, the first to fourth bus rings 21 to 24 are aligned in a direction orthogonal to the axis O. Furthermore, the first to fourth bus rings 21 to 24 are arranged to form the same plane. In the present embodiment, the fourth bus ring 24 is arranged at the innermost position and the third bus ring 23 is arranged at the outermost position. The first bus ring 21 is arranged on the outer side of the fourth bus ring 24 and the second bus ring 22 is arranged between the first bus ring 21 and the third bus ring 23. In other words, the fourth bus ring 24 is arranged on the innermost side of the first to fourth bus rings 21 to 24.

Among the first to fourth bus rings 21 to 24, the fourth bus ring 24 has the largest number of the terminal parts (total of the terminal parts 241, 242 and 243) while the number of the terminals 211 of the first bus ring 21, the number of the terminals 221 of the second bus ring 22 and the number of the terminals 231 of the third bus ring 23 are all the same. The fourth bus ring 24 corresponds to “one bus ring” in the invention and the first to third bus rings 21 to 23 correspond to “other bus rings” in the invention.

The terminals 211, 221 and 231 of the first to third bus rings 21 to 23 protrude radially inward of the electric wires 210, 220 and 230 while the terminal parts 241, 242 and 243 of the fourth bus ring 24 protrude radially outward of the main body part 240. The guide portions 31 to 34 are provided on the inner peripheral side of the electric wire 210 as well as on the outer peripheral side of the arcuate conductor 24A of the fourth bus ring 24.

That is, the one-side end portions 111a, 112a, 113a and the other-side end portions 111b, 112b, 113b of the windings 111, 112 and 113 are connected to the terminals 211, 221, 231 and the terminal parts 241, 242, 243 at positions between the first to third bus rings 21 to 23 and the fourth bus ring 24. The guide portions 31 to 34 of the holding member 3 guide the one-side end portions 111a, 112a, 113a and the other-side end portions 111b, 112b, 113b of the windings 111, 112 and 113 to between the first to third bus rings 21 to 23 and the fourth bus ring 24.

The terminal parts 241, 242 and 243 of the fourth bus ring 24 are arranged between the terminals 211, 221 and 231 of the first to third bus rings 21 to 23. In more detail, as shown in FIG. 3A, the terminal part 241 of the fourth bus ring 24 is arranged between the terminal 211 of the first bus ring 21 and the terminal 231 of the third bus ring 23, the terminal part 242 of the fourth bus ring 24 is arranged between the terminal 211 of the first bus ring 21 and the terminal 221 of the second bus ring 22 and the terminal part 243 of the fourth bus ring 24 is arranged between the terminal 221 of the second bus ring 22 and the terminal 231 of the third bus ring 23.

Each of the terminals 211, 221 and 231 of the first to third bus rings 21 to 23 is formed in the same manner and the terminal 221 will be taken as an example to describe the detailed structure.

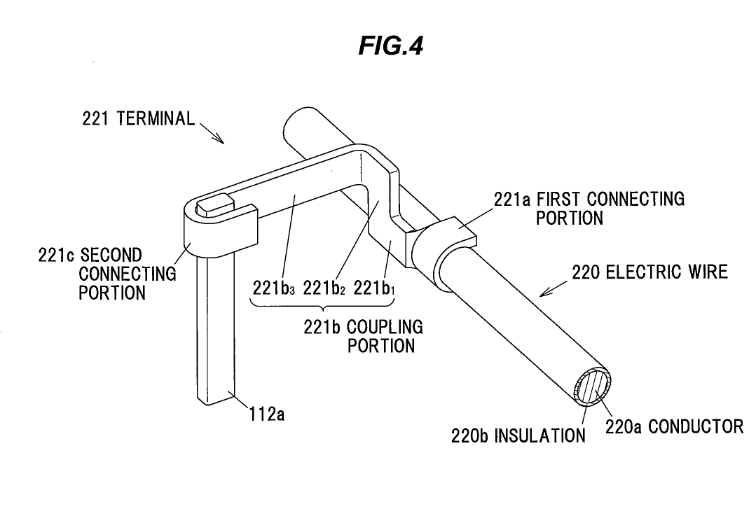

FIG. 4 is a perspective view showing the terminal 221 and the periphery thereof. The terminal 221 is formed by bending a plate-shaped conductor and integrally has a first connecting portion 221a connected to the conductor 220a of the electric wire 220, a second connecting portion 221c connected to the one-side end portion 112a of the winding 112 and a coupling portion 221b for coupling the first connecting portion 221a to the second connecting portion 221c.

The coupling portion 221b is composed of a first coupling portion 221b₁ extending from the first connecting portion 221a along the electric wire 220, a second coupling portion 221b₂ extending from an end portion of the first coupling portion 221b₁ so as to be parallel to an axial direction of the second bus ring 22 and a third coupling portion 221b₃ inwardly extending in a radial direction of the second bus ring 22 from an end portion of the second coupling portion 221b₂. The second connecting portion 221c is provided continuously to the third coupling portion 221b₃ and is formed in a U-shape so as to surround the one-side end portion 112a of the winding 112.

The first connecting portion 221a is clamped and fixed to the conductor 220a of the electric wire 220 and the second connecting portion 221c is fixed to the one-side end portions 112a of the windings 112 by clamping, thereby electrically connecting the conductor 210a to the winding 112 by the terminal 211.

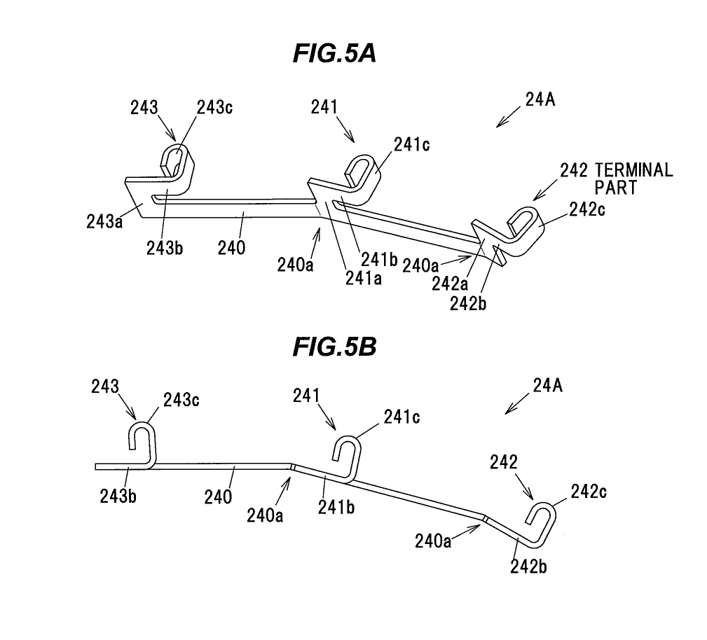

FIGS. 5A and 5B show the arcuate conductor 24A, wherein FIG. 5A is a perspective view and FIG. 5B is a plan view as viewed from an axial direction of the fourth bus ring 24. A metal plate formed of a metal having good conductivity such as copper is punched to obtain a plate-shaped conductor and the arcuate conductor 24A is formed by bending the plate-shaped conductor.

The main body part 240 of the arcuate conductor 24A is shaped into an arc shape by bending at two bent portions 240a. On the main body part 240, the terminal part 241 is provided in the circumferentially middle portion and the terminal parts 242 and 243 are provided at both end portions.

The terminal part 241 has a first coupling portion 241a extending from the main body part 240 so as to be parallel to the axial direction of the fourth bus ring 24, a second coupling portion 241b extending from an end portion of the first coupling portion 241a along the main body part 240 and a connecting portion 241c formed in a U-shape so as to protrude radially outward of the fourth bus ring 24 from an end portion of the second coupling portion 241b.

Likewise, the terminal parts 242 and 243 respectively have first coupling portions 242a and 243a extending from the main body part 240 so as to be parallel to the axial direction of the fourth bus ring 24, second coupling portions 242b and 243b extending from end portions of the first coupling portions 242a and 243a along the main body part 240 and connecting portions 242c and 243c formed in a U-shape so as to protrude radially outward of the fourth bus ring 24 from end portions of the second coupling portions 242b and 243b.

The terminal parts 241, 242 and 243 are electrically connected to the other-side end portions 111b, 112b and 113b of the windings 111, 112 and 113 by clamping the connecting portions 241c, 242c and 243c thereto.

The main body part 240 is housed in the holding groove 304 (see FIGS. 2A to 3B) and the arcuate conductor 24A is thereby held by the holding member 3. The terminal parts 241, 242 and 243 are located out of the holding groove 304 so that the connecting portions 241c, 242c and 243c face the guide portions 34 in an extending direction of the insertion hole 340. Predetermined gaps are formed between the connecting portions 241c, 242c, 243c and the guide portions 34.

In the electric motor 1 configured as described above, the power supply terminals 21a, 22a and 23a are connected to the non-illustrated inverter and three-phase AC current output from the inverter is supplied to the one-side end portions 111a, 112a and 113a of the windings 111, 112 and 113 via the terminals 211, 221 and 231 of the first to third bus rings 21 to 23. The other-side end portions 111b, 112b, 113b of the windings 111, 112 and 113 are connected to the fourth bus ring 24 as a neutral phase and the rotor 12 is rotated with respect to the stator 11 by a rotating magnetic field generated in the windings 111, 112 and 113 by the three-phase AC current.

### COMPARATIVE EXAMPLE

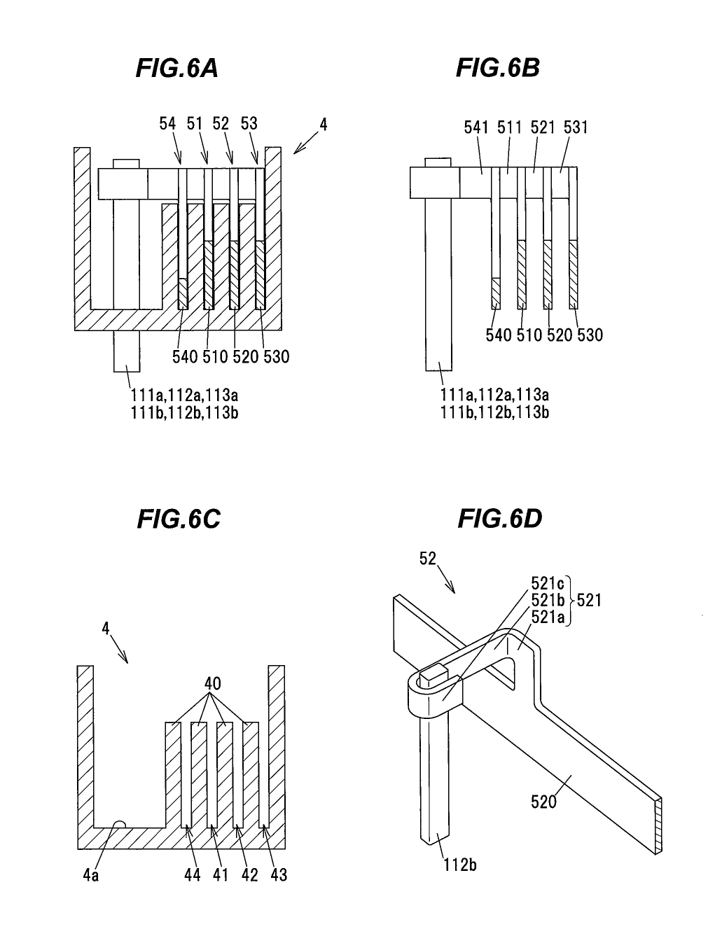

FIGS. 6A to 6D show a holding member 4 and first to fourth bus rings 51 to 54 held thereby in Comparative Example, wherein FIG. 6A is a cross sectional view showing the holding member 4 and the first to fourth bus rings 51 to 54, FIG. 6B is a cross sectional view showing the first to fourth bus rings 51 to 54, FIG. 6C is a cross sectional view showing the holding member 4 and FIG. 6D is a perspective view showing a terminal part 521 of the second bus ring 52 and the periphery thereof

Each of the first to fourth bus rings 51 to 54 is a bus bar formed by bending a plate-shaped metal member. The first bus ring 51 integrally has a main body part 510 and a terminal part 511. Likewise, the second and third bus rings 52 and 53 respectively integrally have main bodies 520, 530 and terminal parts 521, 531. In addition, the fourth bus ring 54 integrally has a main body part 540 and a terminal part 541.

Note that, although the terminal parts 511, 521, 531 and 541 of the first to fourth bus rings 51 to 54 are sequentially aligned in a circumferential direction of the holding member 4 at intervals, the terminal parts 511, 521, 531 and 541 are shown as being overlapped in FIGS. 6A and 6B. In addition, although the terminal parts 511, 521 and 531 of eight each are respectively provided on the first to third bus rings 51 to 53 and twenty-four terminal parts 541 are provided on the fourth bus ring 54, FIGS. 6A and 6B show only one each of the terminal parts 511, 521, 531 and 541.

The one-side end portions 111a of the U-phase windings 111 (see FIG. 1) are connected to the plural terminal parts 511 of the first bus ring 51. Likewise, the one-side end portions 112a and 113a of the V- and W-phase windings 112 and 113 are respectively connected to the plural terminal parts 521 and 531 of the second and third bus rings 52 and 53. In addition, the other-side end portions 111b, 112b and 113b of the U-, V- and W-phase windings 111, 112 and 113 are connected to the plural terminal parts 541 of the fourth bus ring 54.

The main body part 540 of the fourth bus ring 54 is formed to have a smaller width than the main bodies 510, 520 and 530 of the first to third bus rings 51 to 53. In the example shown in FIGS. 6A to 6D, the width of the main body part 540 is about half of those of the main bodies 510, 520 and 530. This is because, although all electric currents supplied to, e.g., the eight U-phase windings 111 flow through the first bus ring 51 and current-carrying capacity of the main body part 510 needs to be ensured so as to correspond thereto, it is enough for the main body part 540 to ensure the capacity corresponding to electric current flowing between the three terminal parts 541 arranged parallel in a circumferential direction. The width of the main body part 540 of the fourth bus ring 54 is the same as that of the main body part 240 of the arcuate conductor 24A in the embodiment (see FIG. 3B).

The holding member 4 has a housing space 41 for housing the main body part 510 of the first bus ring 51, a housing space 42 for housing the main body part 520 of the second bus ring 52, a housing space 43 for housing the main body part 530 of the third bus ring 53 and a housing space 44 for housing the main body part 540 of the fourth bus ring 54. The housing space 44 is formed on the innermost side of the holding member 4 and the housing space 43 is formed on the outermost side.

The housing spaces 41 to 44 are partitioned by plural annular partition walls 40. The height of the partition wall 40 from a bottom surface 4a of the holding member 4 is higher than the widths of the main bodies 510, 520, 530 and 540 of the first to fourth bus rings 51 to 54, and accordingly, creepage and spatial distances between the first to fourth bus rings 51 to 54 are maintained to not less than a level which allows insulation reliability to be ensured.

As shown in FIG. 6D, the terminal part 521 of the second bus ring 52 has a first coupling portion 521a extending in a width direction of the main body part 520, a second coupling portion 521b extending in a direction orthogonal to the main body part 520 and a connecting portion 521c provided at a tip portion of the second coupling portion 521b. The other-side end portion 112b of the winding 112 is connected to the connecting portion 521c by clamping. Note that, the terminal parts 511, 531 and 541 are also formed in the same manner as the terminal part 521 but length of a portion corresponding to the second coupling portion 521b of the terminal part 521 is different from each other.

The radial width of the holding member 4 can be made smaller than that of the holding member 3 of the embodiment by arranging the first to fourth bus rings 51 to 54 so that the main bodies 510, 520, 530 and 540 are parallel to each other. However, in such a case, a height dimension of the partition wall 40 needs to be kept to not less than width dimensions of the main bodies 510, 520, 530 and 540 in order to ensure insulation reliability and an axial length is thus greater than the holding member 3.

Since the electricity collection and distribution ring 10 and the stator 11 are aligned along the rotational axis of the rotor 12 as described above, making a radial dimension of the holding member 3 smaller than that of the teeth 110 does not contribute to downsizing of the electric motor 1. The holding member 3 in the present embodiment has a shorter axial length than the holding member 4 in Comparative Example, which allows the electric motor 1 to be downsized by the difference of the length.

### Functions and Effects of the Embodiment

The following functions and effects are obtained in the embodiment.

(1) Since the terminal parts 241, 242 and 243 of the fourth bus ring 24 are integrally formed by bending a plate-shaped metal member, work of connecting the main body part 240 to the terminal parts 241, 242 and 243 is no longer needed. This allows man-hours for manufacturing the electricity collection and distribution ring 10 to be reduced as compared to the case where the fourth bus ring 24 is composed of, e.g., an annular wire and plural terminal parts connected thereto by clamping. Especially, since the fourth bus ring 24 has more terminal parts than the first to third bus rings 21 to 23, forming the fourth bus ring 24 (the arcuate conductor 24A) by bending a plate-shaped metal member allows the maximum effect of reducing the man-hours to be exerted.

(2) Since the fourth bus ring 24 is arranged on the innermost side of the first to fourth bus rings 21 to 24, the terminals 211, 221 and 231 of the first to third bus rings 21 to 23 do not cross over the fourth bus ring 24. In other words, the terminals 211, 221 and 231 protruding radially inward do not three-dimensionally intersect the fourth bus ring 24.

As a result, it is possible to sufficiently ensure the spatial and creepage distances between the terminals 211, 221, 231 and the fourth bus ring 24. In addition, the electric wires 210, 220 and 230 which are respectively covered with the insulations 210b, 220b and 230b allow a distance between the electric wires 210, 220 and the terminal 231 crossing over the wires 210, 220 and a distance between the electric wire 210 and the terminal 221 crossing over the wire 210 to be reduced. As a result, it is possible to reduce a thickness (a width in a direction along the axis O) of the electricity collection and distribution ring 10.

(3) Since the terminal parts 241, 242 and 243 of the fourth bus ring 24 are arranged between the terminals 211, 221 and 231 of the first to third bus rings 21 to 23, spaces in the radial direction of the electricity collection and distribution ring 10 for arranging the terminal parts 241, 242 and 243 and the terminals 211, 221 and 231 can be shared and it is thus possible to reduce a radial width of the electricity collection and distribution ring 10. In addition, this allows a diameter of the electricity collection and distribution ring 10 to be reduced.

The coupling portion 221b of the terminal 221 has the first coupling portion 221b₁, the second coupling portion 221b₂ and the third coupling portion 221b₃ and is configured such that the third coupling portion 221b₃ crosses over the electric wire 210. Since the first coupling portion 221b₁ extends along the electric wire 220 and the second coupling portion 221b₂ extends parallel to the axial direction from an end portion of the first coupling portion 221b₁, it is possible to reduce the thickness of the coupling portion 221b (the thickness in the radial direction of the electricity collection and distribution ring 10) at a portion interposed between the electric wire 210 and the electric wire 220. This allows the radial width and the diameter of the electricity collection and distribution ring 10 to be reduced.

(5) Since the first to third bus rings 21 to 23 are insulated wires each formed by covering a conductor with an insulation, it is possible to easily ensure insulation reliability between the first to third bus rings 21 to 23 and between the fourth bus ring 24 and the first to third bus rings 21 to 23. Since this allows insulation reliability to be ensured without providing, e.g., partition walls between the fourth bus ring 24 and the first to third bus rings 21 to 23 which increase a radial length of the holding member 3, it is possible to downsize the electric motor 1 as compared to the case of using, e.g., the holding member 4 in Comparative Example.

(6) Since the one-side end portions 111a, 112a, 113a and the other-side end portions 111b, 112b, 113b of the windings 111, 112 and 113 are connected to the terminals 211, 221, 231 and the terminal parts 241, 242, 243 at positions between the first to third bus rings 21 to 23 and the fourth bus ring 24, the terminals 211, 221 and 231 do not intersect the fourth bus ring 24. In other words, since the terminals 211, 221 and 231 do not cross over the main body part 240 of the fourth bus ring 24 across the radial direction, it is possible to ensure the spatial distance between the terminals 211, 221, 231 and the main body part 240 of the fourth bus ring 24 without causing an increase in the size of the holding member 3. As a result, it is possible to downsize the electricity collection and distribution ring 10 and the electric motor 1.

(7) Since the one-side end portions 111a, 112a, 113a and the other-side end portions 111b, 112b, 113b of the windings 111, 112 and 113 are guided to the positions between the first to third bus rings 21 to 23 and the fourth bus ring 24 by the guide portions 31 to 34 of the holding member 3, it is possible to easily assemble electricity collection and distribution ring 10 to the stator 11.

Although the embodiment of the invention has been described, the invention according to claims is not to be limited to the above-mentioned embodiment. Further, please note that all combinations of the features described in the embodiment are not necessary to solve the problem of the invention.

In addition, the invention can be appropriately modified and implemented without departing from the gist thereof. For example, although the fourth bus ring 24 composed of the plural arcuate conductors 24A has been described in the embodiment, it is not limited thereto. The fourth bus ring 24 may be composed of one annular main body part and plural terminal parts provided thereon.

In addition, the case where the fourth bus ring 24 is arranged on the innermost side of the first to fourth bus rings 21 to 24 has been described in the embodiment, it is not limited thereto. The fourth bus ring 24 may be arranged on the outermost side of the first to fourth bus rings 21 to 24. In this case, the terminals 211, 221 and 231 of the first to third bus rings 21 to 23 protrude radially outward of the electric wires 210, 220 and 230 and the terminal parts 241, 242 and 243 of the fourth bus ring 24 protrude radially inward of the main body part 240. Then, the guide portions 31 to 34 are provided on the outer peripheral side of the electric wire 230 as well as on the inner peripheral side of the main body part 240 of the arcuate conductor 24A.

What is claimed is:

1. An electricity collection and distribution ring, comprising:
a plurality of bus rings for collecting and distributing respective phase currents to multiple-phase windings wound around a plurality of circularly-arranged teeth,
wherein the plurality of bus rings each comprise a plurality of terminal parts and a main body part electrically conducted to the plurality of terminal parts,
wherein one bus ring having the largest number of terminal parts among the plurality of bus rings comprises the main body part and the terminal parts that are integrally formed with a plate-shaped metal member being bent, and
wherein other bus rings of the plurality of bus rings excluding the one bus ring are configured such that the main body part comprises an annular insulated wire comprising a conductor and an insulation covering the conductor, and the terminal parts are connected to the main body part at a plurality of positions where the conductor is exposed with the insulation removed.

2. The electricity collection and distribution ring according to claim 1, wherein the plurality of bus rings are concentrically arranged about an axis of the plurality of circularly-arranged teeth.

3. The electricity collection and distribution ring according to claim 2, wherein the one bus ring is arranged on the innermost or outermost side of the plurality of bus rings.

4. The electricity collection and distribution ring according to claim 3, wherein the terminal parts of the one bus ring protrude radially outward and the terminal parts of the other bus rings protrude radially inward, and
wherein one-side end portions and other-side end portions of the multiple-phase windings are connected to the terminal parts at positions between the other bus rings and the one bus ring.

5. The electricity collection and distribution ring according to claim 4, wherein the terminal part of the one bus ring is arranged between the terminal parts of the other bus rings.

6. The electricity collection and distribution ring according to claim 2, wherein the terminal parts of the other bus rings each comprises a first coupling portion extending along the main body part and a second coupling portion extending parallel to an axial direction from an end portion of the first coupling portion.

7. The electricity collection and distribution ring according to claim 1, wherein the plurality of teeth and the multiple-phase windings compose a stator of a three-phase AC motor to which U-, V- and W-phase currents are supplied,
wherein the other bus rings comprise a first bus ring having the plurality of terminal parts connected to one-side end portions of a plurality of U-phase windings, a second bus ring having the plurality of terminal parts connected to one-side end portions of a plurality of V-phase windings and a third bus ring having the plurality of terminal parts connected to one-side end portions of a plurality of W-phase windings, and
wherein the one bus ring comprises a neutral-phase bus ring connected to respective other-side end portions of the plurality of U-, V- and W-phase windings.

8. The electricity collection and distribution ring according to claim 7, wherein the one-side end portions and the other-side end portions of the plurality of U-, V- and W-phase windings are connected to the terminal parts at positions between the first to third bus rings and the neutral-phase bus ring.

9. The electricity collection and distribution ring according to claim 8, further comprising an annular holding member for holding the first to third bus rings and the neutral-phase bus ring,
wherein the holding member comprises guide portions for guiding the one-side end portions and the other-side end portions of the plurality of U-, V- and W-phase windings to between the first to third bus rings and the neutral-phase bus ring.

10. An electric motor, comprising:
the electricity collection and distribution ring according to claim 1;
a stator comprising the plurality of teeth and the multiple-phase windings; and
a rotor that is rotated with respect to the stator by a magnetic field of the multiple-phase winding.
